(19) United States
(12) Patent Application Publication
(10) Pub. No.: US 2013/0328758 A1
(43) Pub. Date: Dec. 12, 2013

(54) DIFFERENTIAL ACTIVE-MATRIX DISPLAYS

(71) Applicants: David A. STRONKS, Sunnyvale, CA (US); Hopil BAE, Cupertino, CA (US)

(72) Inventors: David A. STRONKS, Sunnyvale, CA (US); Hopil BAE, Cupertino, CA (US)

(73) Assignee: Apple Inc., Cupertino, CA (US)

(21) Appl. No.: 13/492,782

(22) Filed: Jun. 8, 2012

(51) Int. Cl. G09G 3/36

(52) U.S. Cl. 345/88; 345/92

(57) ABSTRACT

A differential subpixel of a display apparatus includes a first drive transistor and a second drive transistor. The first drive transistor has a first drive signal with a first polarity and the second drive transistor has a second drive signal with a second polarity. The first polarity is opposed to the second polarity and the first drive signal and the second drive signal are configured to be driven with complementary differential signals.

### FIELD OF THE DESCRIBED EMBODIMENTS

The described embodiments relate generally to displays, and more particularly, exemplary embodiments of the present invention relate to differential active-matrix displays.

### BACKGROUND

Conventionally, liquid crystal displays (LCD) rely on a plurality of N-channel metal-oxide-semiconductor (NMOS) thin-film transistors (TFT) arranged in a matrix to drive a plurality of liquid crystal cells which form individual pixels. As a source voltage is transferred from a particular NMOS TFT to a single liquid crystal cell, a variable shutter is formed dependent on the source voltage such that light passing through the liquid crystal cell is attenuated.

For example, turning to FIG. 1, a conventional pixel row is illustrated. Each pixel 101, 102, and 103 of the pixel row is driven by a single gate line 110. An individual subpixel of the pixel row is illustrated in FIG. 2. As shown, NMOS drive transistor 201 is controlled through gate signal 110. The gate line 110 introduces parasitic capacitances 202 and 203 between and around individual liquid crystal cell 204. Therefore, when refreshing the cell 204 with a source voltage, the parasitic capacitances 202 and 203 introduce a voltage kickback due to capacitive coupling. This is illustrated more clearly in FIG. 3.

As shown in FIG. 3, parasitic capacitance introduced through gate control lines proximate NMOS TFTs may perturb stabilization of individual liquid crystal cells with voltage kickbacks shown in region 301. Furthermore, stabilization of the individual cells (shown in region 302) delays appropriate voltage settings for the cells, thereby introducing display artifacts, brightness disparity across cells, and other undesirable effects.

Therefore, new addressing and component layouts are described herein which overcome and/or mitigate the undesirable effects of conventional LCD technology.

### SUMMARY OF THE DESCRIBED EMBODIMENTS

This paper describes various embodiments that relate to display technology, and more particularly, to differential active-matrix displays.

According to one embodiment of the present invention, a differential subpixel of a display apparatus includes a first drive transistor and a second drive transistor. The first drive transistor has a first drive signal with a first polarity and the second drive transistor has a second drive signal with a second polarity. Furthermore, the first polarity is opposed to the second polarity and the first drive signal and the second drive signal are configured to be driven with complementary differential signals.

According to another embodiment of the present invention, a differential pixel of a display device includes a first grouping of subpixels and a second grouping of subpixels. The first grouping of subpixels is configured to be driven by a first drive signal with a first polarity. The second grouping of subpixels is configured to be driven by a second drive signal with a second polarity. Furthermore, the first polarity is opposed to the second polarity and the first drive signal and the second drive signal are configured to be driven with complementary differential signals.

According to yet another embodiment of the present invention, a differential display device includes a display controller and a differential display matrix coupled to the display controller. The differential display matrix includes a first grouping of subpixels configured to be driven by a plurality of first drive signals with a first polarity and a second grouping of subpixels configured to be driven by a plurality of second drive signals with a second polarity. The first polarity is opposed to the second polarity.

According to yet another embodiment of the present invention, a method for driving a differential subpixel of a display device includes arranging a first display subpixel with a first drive transistor, the first drive transistor having a first drive signal with a first polarity and arranging a second display subpixel with a second drive transistor, the second drive transistor having a second drive signal with a second polarity. The first polarity is opposed to the second polarity. The method further includes simultaneously driving the first and second drive transistors with differential drive signals enabling the first and second display subpixels. The differential drive signals reduce spurious induced voltages on the first and the second display subpixels.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a row of pixels.

FIG. 2 is a schematic of a subpixel of FIG. 1.

FIG. 3 is a graph of a refresh cycle of the subpixel of FIG. 2.

FIG. 4 illustrates a row of differential pixels according to an embodiment of the present invention.

FIG. 5 illustrates a row of differential pixels according to another embodiment of the present invention.

FIG. 6 illustrates a first type of subpixel of FIG. 5.

FIG. 7 illustrates a second type of subpixel of FIG. 5.

FIG. 8 is a graph of a refresh cycle of subpixels of FIG. 5.

FIG. 9 illustrates a schematic of a differential display according to an exemplary embodiment of the present invention.

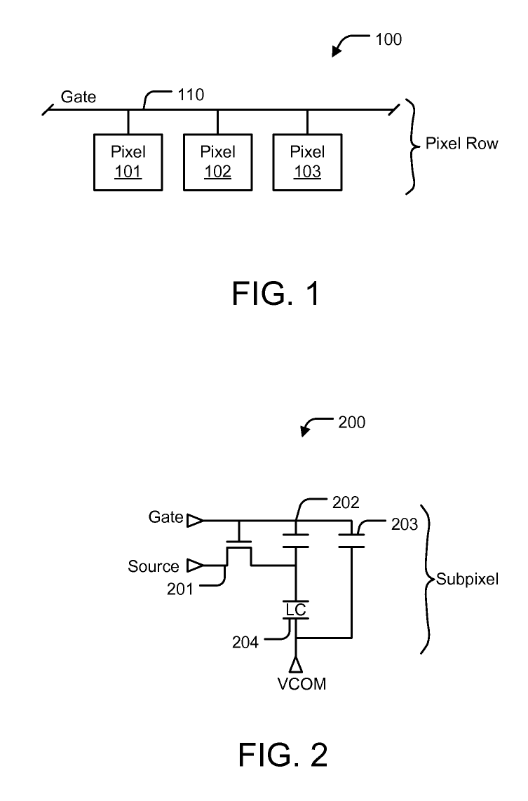

### DETAILED DESCRIPTION OF SELECTED EMBODIMENTS

Representative implementations of methods and apparatuses according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other implementations are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The examples and embodiments provided below describe differential display devices including differential active-matrices. A differential active matrix may include at least two types of drive transistors arranged in a grid or matrix pattern and configured to drive a plurality of individual subpixels. Each type of drive transistor may be driven by a particular drive or gate line which carries a gate signal opposite to the other type of drive transistor. This form of differential signaling reduces the effects of parasitic capacitance introduced between control lines and individual subpixel components, thereby mitigating the drawbacks of conventional displays.

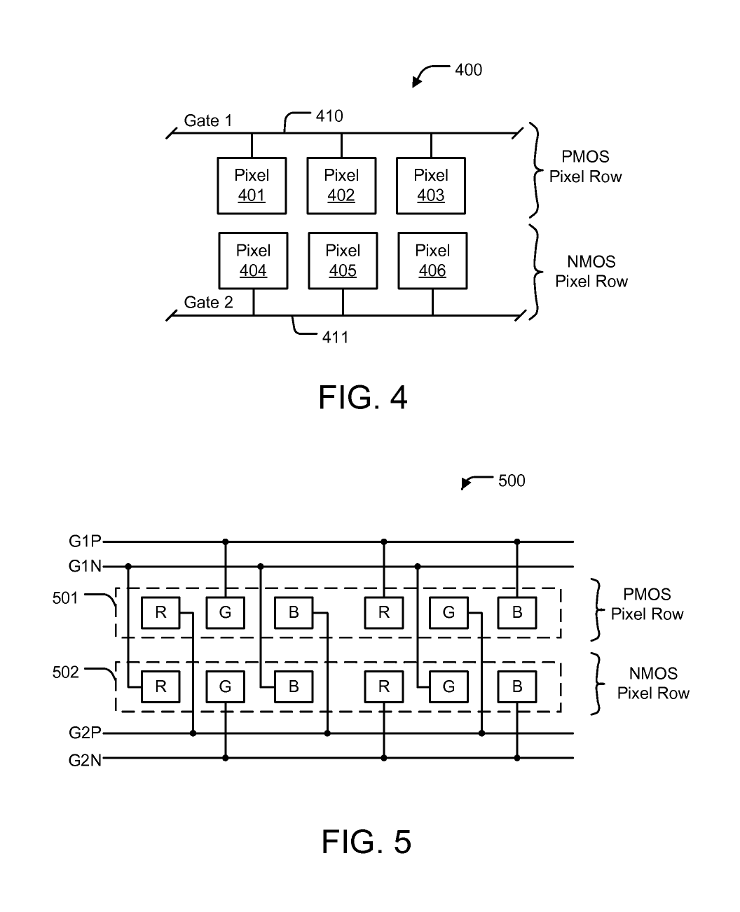

For example, FIG. 4 illustrates a row 400 of differential pixels according to an embodiment of the present invention. As shown, a row of differential pixels includes a first row of a first type of pixels and a second row of a second type of pixels. According to this embodiment, the first row of pixels includes pixels comprising P-channel MOS (PMOS) drive transistors. The first row of pixels is configured to be controlled through application of appropriate gate voltages at gate line 410. The second row of pixels includes pixels comprising NMOS drive transistors. The second row of pixels is configured to be controlled through application of appropriate gate voltages at gate line 411. As gate line 410 is configured to control PMOS transistors, the gate line 410 is configured to be kept at a relatively high voltage and de-asserted to control gates of associated PMOS transistors. Thus, gate line 410 is configured to transmit a first drive signal at a first polarity. Conversely, as gate line 411 is configured to control NMOS transistors, the gate line 411 is configured to be kept at a relatively low voltage compared to gate line 410, and is asserted to control gates of associated NMOS transistors. Thus, fate line 411 is configured to transmit a second drive signal at a second polarity. The first polarity may be opposed to the second polarity, and therefore, gate lines 410 and 411 are complementary, fully differential signal lines driving different types of transistors. Accordingly, the effects of parasitic capacitance may be reduced due to the opposing voltages applies through gate lines 410 and 410.

Although illustrated as being individual lines, it should be understood that there may be more or less gate lines included in any desired implementation to further enhance the benefits apparent from using differential signal lines and differential components across pixel rows. For example, additional gate lines may be included in relatively close proximity to those illustrated to more effectively mitigate the effects of parasitic capacitance. This is described more fully below with reference to FIGS. 5-7.

FIG. 5 illustrates a row 500 of differential pixels according to another embodiment of the present invention. As shown, the row 500 includes a PMOS pixel row and a NMOS pixel row. The PMOS pixel row includes pixels 501 comprising PMOS drive transistors. The NMOS pixel row includes pixels 502 comprising NMOS drive transistors. As also shown, individual pixels are separated into Red (R), Green (G), and Blue (B) subpixels to allow for full color display. Each grouping of pixels for the PMOS pixel row includes two sets of RGB subpixels. Furthermore, each grouping pixels for the NMOS pixel row also includes two sets of RGB subpixels.

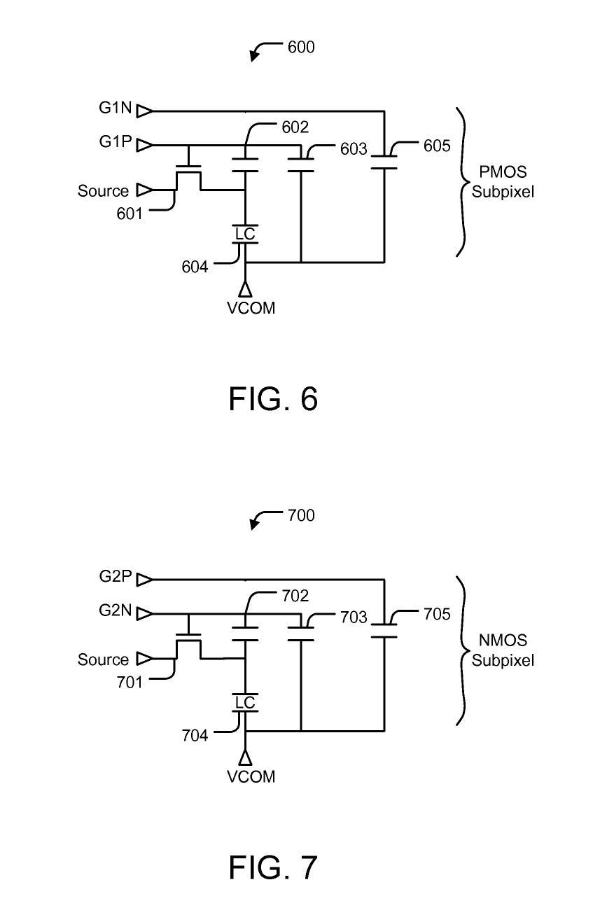

As further illustrated, the pixels 501 and 502 are driven by at least four separate gate control lines G1P, G1N, G2P, and G2N. Gate line G1P may be configured to transmit a first drive signal of a first polarity. Gate line G1N may be configured to transmit a second drive signal of a second polarity. Gate line G2P may be configured to transmit a third drive signal of the first polarity. Gate line G2N may be configured to transmit a fourth drive signal of the second polarity. Similarly to that described above, the first polarity may be opposed to the second polarity to create differential signaling. The four separate gate control lines are configured to drive disparate pixels across the entire row 500 such that parasitic capacitances are introduced between two types of control lines and associated PMOS and NMOS drive transistors. For example, gate control lines G1P and G2P are configured to drive PMOS drive transistors and gate control lines G1N and G2N are configured to drive NMOS drive transistors. Furthermore, Gate control lines G1P and G1N are arranged proximate one another while gate control lines G2P and G2N are also arranged proximate one another. Therefore, capacitive coupling is apparent across pixels 501 and 502 and gate control lines G1P, G1N, G2P, and G2N. Hereinafter, this capacitive coupling is described more fully with reference to FIGS. 6-7 below.

FIG. 6 illustrates a first type of subpixel 600 of FIG. 5. The subpixel 600 includes at least one drive transistor 601. The drive transistor 601 may be a P-channel metal-oxide-semiconductor (PMOS) thin-film transistor (TFT). The transistor 601 may be in communication with a source signal Source through a source electrode of the transistor, which may be a matrix-addressable signal in communication with a display controller. The transistor 601 is also in communication with the gate control signal G1P through a gate electrode of the transistor, which may also be a matrix-addressable signal in communication with a display controller. The transistor 601 is in further communication with liquid crystal cell 604 through a drain electrode of the transistor. The liquid crystal cell 604 may be any suitable liquid crystal cell, including a layer of molecules aligned between two transparent electrodes, a twisted nematic cell, or any other suitable liquid crystal cell. The transparent electrodes may be formed of Indium Tin Oxides (ITO), transparent aluminum oxides, or any other suitable transparent or translucent conductive or semiconductive materials. The liquid crystal cell 604 may be in communication with a common signal VCOM, which may be a signal common across a number of subpixels in a display device.

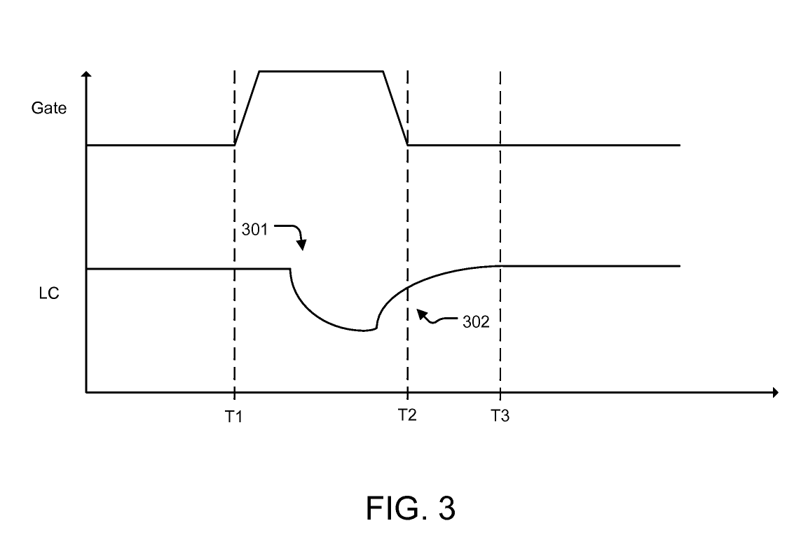

The subpixel 600 may be arranged in relatively close proximity to both gate control signals G1N and G1P. Therefore, parasitic capacitances 602, 603, and 605 may be formed through capacitive coupling of electrodes of the liquid crystal cell 604 and gate control lines G1N and G1P. Parasitic capacitances 603 and 605 greatly influence voltage kickback at the liquid crystal cell 604 during a refresh cycle. However, because gate control lines G1N and G1P carry opposing, differential voltage signals, the relative charge state of the capacitances 603 and 605 may be opposite and destructively interfere during any refresh cycle. In this manner, as gate control lines G1N and G1P are asserted and de-asserted, respectively, the charge state of the capacitances 603 and 605 may alternate opposite to one another, and therefore cancel the typical voltage kickback seen in conventional display devices (e.g., as illustrated in FIG. 3). Therefore, the voltage kickback may be reduced or mitigated entirely, and display artifacts and brightness disparity may also be reduced or eliminated.

Turning now to FIG. 7, a second type of subpixel 700 of FIG. 5 is illustrated. The subpixel 700 includes at least one drive transistor 701. The drive transistor 701 may be a N-channel metal-oxide-semiconductor (NMOS) thin-film transistor (TFT). The transistor 701 may be in communication with a source signal Source through a source electrode of the transistor, which may be a matrix-addressable signal in communication with a display controller. The transistor 701 is also in communication with the gate control signal G2N through a gate electrode of the transistor, which may also be a matrix-addressable signal in communication with a display controller. The transistor 701 is in further communication with liquid crystal cell 704 through a drain electrode of the transistor. The liquid crystal cell 704 may be any suitable liquid crystal cell, including a layer of molecules aligned between two transparent electrodes, a twisted nematic cell, or any other suitable liquid crystal cell. The transparent electrodes may be formed of Indium Tin Oxides (ITO), transparent aluminum oxides, or any other suitable transparent or translucent conductive or semiconductive materials. The liquid crystal cell 704 may be in communication with a common signal VCOM, which may be a signal common across a number of subpixels in a display device.

The subpixel 700 may be arranged in relatively close proximity to both gate control signals G2N and G2P. Therefore, parasitic capacitances 702, 703, and 705 may be formed through capacitive coupling of electrodes of the liquid crystal cell 704 and gate control lines G2N and G2P. Parasitic capacitances 703 and 705 greatly influence voltage kickback as described above. However, because gate control lines G2N and G2P carry opposing, differential voltage signals, the relative charge state of the capacitances 703 and 705 may be opposite and destructively interfere. In this manner, as gate control lines G2N and G2P are asserted and de-asserted, respectively, the charge state of the capacitances 703 and 705 may alternate opposite to one another, and therefore cancel the typical voltage kickback seen in conventional display devices (e.g., as illustrated in FIG. 3). Therefore, the voltage kickback may be reduced or mitigated entirely, and display artifacts and brightness disparity may also be reduced or eliminated.

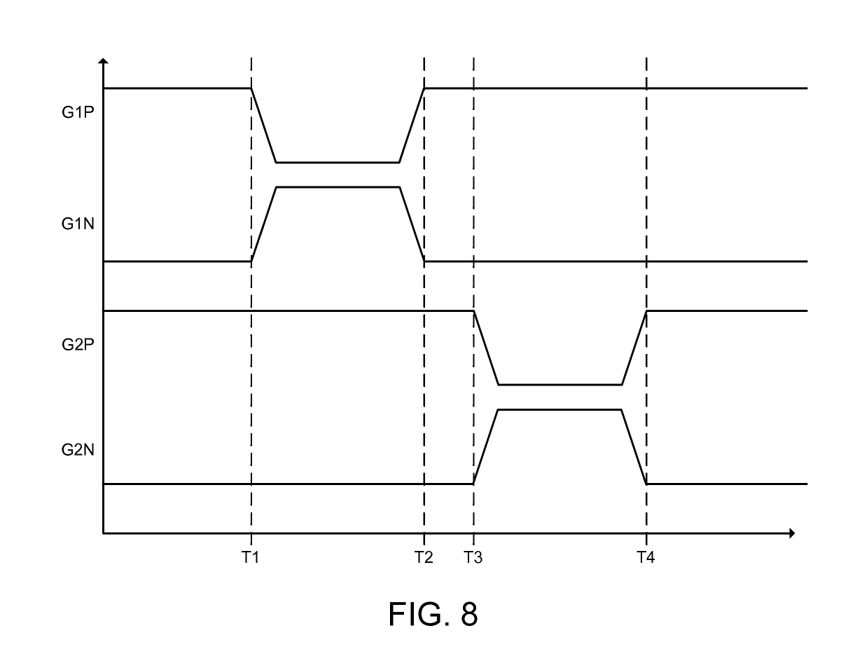

Hereinafter, a refresh cycle of subpixels of FIG. 5 is described with reference to FIG. 8. As illustrated, the first drive signal transmitted at G1P and the second drive signal transmitted at G1N are fully differential signals which are complementary to one another. At time T1, the first drive signal G1P is de-asserted while the second drive signal G1N is asserted in a relatively simultaneous manner until a time T2. During this refresh cycle between times T1 and T2, the charge states of parasitic capacitances between both PMOS and NMOS subpixels driven by these drive signals (e.g., 603, 605) are cancelled out or reduced. As further illustrated, the third drive signal transmitted at G2P and the fourth drive signal transmitted at G2N are fully differential signals which are also complementary to one another. At time T3, the third drive signal G2P is de-asserted while the fourth drive signal G2N is asserted in a relatively simultaneous manner until time T4. The charge states of parasitic capacitances between both PMOS and NMOS subpixels driven by these drive signals (e.g., 703, 705) are cancelled out or reduced.

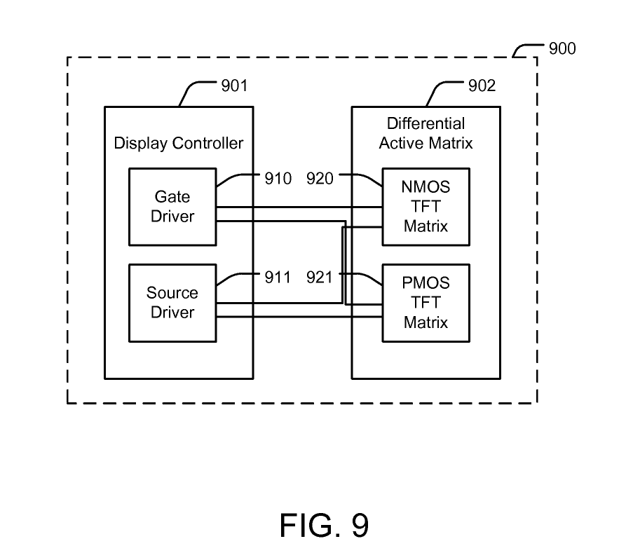

Although described above as related specifically to small groupings of subpixels for a display device, it should be readily understood that the techniques herein are extensible to entire display panels to create a full differential display with reduced artifacts and brightness disparity. For example, FIG. 9 illustrates a schematic of a differential display 900 according to an exemplary embodiment of the present invention.

The display 900 includes a display controller 901 arranged therein. The display controller 901 may include at least a gate driver 910 configured to drive differential gate or drive signals as described above. For example, the gate driver 910 may be configured to provide the first, second, third, and fourth drive signals G1P, G1N, G2P, and G2N, respectively. Thus, the gate driver 910 may be capable of driving differential pixels as described above.

The display controller 901 may further include source driver 911 configured to provide source signals across at least a portion of display 900. The source signals may be similar to those described above, for example, being configured to provide refresh or write voltages to subpixels of the display 900.

The display 900 further includes a differential display matrix 902 coupled to the display controller 901. The differential display matrix 902 may be an active matrix comprising a plurality of pixel groupings arranged in a matrix. For example, the display matrix 902 may include a NMOS TFT matrix 920 and a PMOS TFT matrix 921. Both the NMOS and PMOS display matrices may be arranged proximate or overlapping one another to create the pixel groupings described with reference to FIG. 5. Thus, parasitic capacitances apparent in conventional display designs are overcome through the arrangement shown in FIG. 9. For example, the drive signals provided at gate controller 910 may be timed similarly to those illustrated in FIG. 8 such that charge states of parasitic capacitances are opposite one another, thereby reducing or eliminating voltage kickback and reducing stabilization time of individual liquid crystal cells.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A differential subpixel of a display apparatus, comprising:
a first drive transistor, the first drive transistor having a first drive signal with a first polarity; and
a second drive transistor, the second drive transistor having a second drive signal with a second polarity, wherein the first polarity is opposed to the second polarity and wherein the first drive signal and the second drive signal are configured to be driven with complementary differential signals.

2. The differential subpixel of claim 1, further comprising:
a first liquid crystal cell coupled to the first drive transistor; and
a second liquid crystal cell coupled to the second drive transistor.

3. The differential subpixel of claim 2, wherein:
the first drive transistor is a P-channel metal-oxide-semiconductor (PMOS) transistor; and
the second drive transistor is a N-channel metal-oxide-semiconductor (NMOS) transistor.

4. The differential subpixel of claim 2, wherein:
the first drive transistor and the second drive transistor are thin-film transistors (TFT).

5. The differential subpixel of claim 2, wherein:
the first drive transistor is a PMOS TFT; and
the second drive transistor is a NMOS TFT.

6. A differential pixel of a display device, comprising:
a first grouping of subpixels, the first grouping of subpixels configured to be driven by a first drive signal with a first polarity; and
a second grouping of subpixels, the second grouping of subpixels configured to be driven by a second drive signal with a second polarity, wherein the first polarity is opposed to the second polarity and wherein the first drive signal and the second drive signal are configured to be driven with complementary differential signals.

7. The differential pixel of claim 6, wherein the first and second groupings of subpixels include Red subpixels, Green subpixels, and Blue subpixels.

8. The differential pixel of claim 6, wherein the first grouping of subpixels includes a plurality of subpixels, wherein each subpixel of the plurality of subpixels comprises:
a drive transistor configured to be driven by the first drive signal; and
a liquid crystal cell coupled to the drive transistor.

9. The differential pixel of claim 8, wherein each drive transistor is a P-channel metal-oxide-semiconductor (PMOS) transistor.

10. The differential pixel of claim 9, wherein the second grouping of subpixels includes a plurality of subpixels, wherein each subpixel of the plurality of subpixels comprises:
a drive transistor configured to be driven by the second drive signal; and
a liquid crystal cell coupled to the drive transistor.

11. The differential pixel of claim 10, wherein each drive transistor is a N-channel metal-oxide-semiconductor (NMOS) transistor.

12. The differential pixel of claim 6, wherein:
the first grouping of subpixels is further configured to be driven by a third drive signal with the first polarity; and
the second grouping of subpixels is further configured to be driven by a fourth drive signal with the second polarity, wherein the third drive signal and the fourth drive signal are configured to be driven with complementary differential signals.

13. The differential pixel of claim 12, wherein the first grouping of subpixels includes a plurality of subpixels, wherein each subpixel of the plurality of subpixels comprises:
a drive transistor configured to be driven by one of the first drive signal and the third drive signal; and
a liquid crystal cell coupled to the drive transistor.

14. The differential pixel of claim 13, wherein each drive transistor is a P-channel metal-oxide-semiconductor (PMOS) transistor.

15. The differential pixel of claim 14, wherein the second grouping of subpixels includes a plurality of subpixels, wherein each subpixel of the plurality of subpixels comprises:
a drive transistor configured to be driven by one of the second drive signal and the fourth drive signal; and
a liquid crystal cell coupled to the drive transistor.

16. The differential pixel of claim 15, wherein each drive transistor is a N-channel metal-oxide-semiconductor (NMOS) transistor.

17. A differential display device, comprising:
a display controller; and
a differential display matrix coupled to the display controller, the differential display matrix comprising:
a first grouping of subpixels, the first grouping of subpixels configured to be driven by a plurality of first drive signals with a first polarity; and
a second grouping of subpixels arranged proximate the first grouping of subpixels, the second grouping of subpixels configured to be driven by a plurality of second drive signals with a second polarity, wherein the first polarity is opposed to the second polarity.

18. The differential display device of claim 17, wherein the display controller comprises:
a gate driver portion configured to provide the first drive signals and the second drive signals.

19. The differential display device of claim 17, wherein the display controller comprises:
a source driver configured to provide source signals to each pixel of the first grouping of subpixels and the second grouping of subpixels.

20. The differential display device of claim 17, wherein the first grouping of subpixels is arranged as an active matrix driven with P-channel metal-oxide-semiconductor (PMOS) transistors.

21. The differential display device of claim 20, wherein the second grouping of subpixels is arranged as an active matrix driven with N-channel metal-oxide-semiconductor (NMOS) transistors.

22. The differential display device of claim 17, wherein the first and second groupings of subpixels include Red subpixels, Green subpixels, and Blue subpixels.

23. The differential display device of claim 17, wherein the first grouping of subpixels includes a plurality of subpixels, wherein each subpixel of the plurality of subpixels comprises:
a drive transistor configured to be driven by at least one of the first drive signals; and
a liquid crystal cell coupled to the drive transistor.

24. The differential display device of claim 23, wherein the second grouping of subpixels includes a plurality of subpixels, wherein each subpixel of the plurality of subpixels comprises:
a drive transistor configured to be driven by at least one of the second drive signals; and
a liquid crystal cell coupled to the drive transistor.

25. The differential display device of claim 17, wherein:
the first grouping of subpixels is further configured to be driven by third drive signals with the first polarity; and
the second grouping of subpixels is further configured to be driven by fourth drive signals with the second polarity, wherein the third drive signals and the fourth drive signals are configured to be driven with complementary differential signals.

26. The differential display device of claim 25, wherein the first grouping of subpixels includes a plurality of subpixels, wherein each subpixel of the plurality of subpixels comprises:
a drive transistor configured to be driven by one of the first drive signals and the third drive signals; and
a liquid crystal cell coupled to the drive transistor.

27. The differential display device of claim 26, wherein the second grouping of subpixels includes a plurality of subpixels, wherein each subpixel of the plurality of subpixels comprises:
a drive transistor configured to be driven by one of the second drive signal and the fourth drive signal; and
a liquid crystal cell coupled to the drive transistor.

28. A method for driving a differential subpixel of a display device, the method comprising:
arranging a first display subpixel with a first drive transistor, the first drive transistor having a first drive signal with a first polarity;
arranging a second display subpixel with a second drive transistor, the second drive transistor having a second drive signal with a second polarity; wherein the first polarity is opposed to the second polarity; and
simultaneously driving the first and second drive transistors with differential drive signals enabling the first and second display subpixels, wherein the differential drive signals reduce spurious induced voltages on the first and the second display subpixels.

29. The method of claim 28, further comprising:
arranging a third display subpixel with a third drive transistor, the third drive transistor having a third drive signal with the first polarity;
arranging a fourth display subpixel with a fourth drive transistor, the fourth drive transistor having a fourth drive signal with the second polarity; and
simultaneously driving the third and fourth drive transistors with differential drive signals enabling the third and fourth display subpixels, wherein the differential drive signals reduce spurious induced voltages on the third and the fourth display subpixels.
